(19) United States
(12) Patent Application Publication
(10) Pub. No.: US 2008/0307034 A1
(43) Pub. Date: Dec. 11, 2008

(54) System and Method of Enterprise and On-Line Franchise Models for E-Commerce Website

(75) Inventors: Michael R. FLEET, Tempe, AZ (US); Joshua MANLEY, Tempe, AZ (US); Robert J. SCHOBER, Tempe, AZ (US)

Correspondence Address: QUARLES & BRADY LLP, RENAISSANCE ONE, TWO NORTH CENTRAL AVENUE, PHOENIX, AZ, 85004-2391, US

(73) Assignee: USTRIVE2, INC., Phoenix, AZ (US)

(21) Appl. No.: 11/940,974

(22) Filed: Nov. 15, 2007

Related U.S. Application Data
(60) Provisional application No. 60/942,616, filed on Jun. 7, 2007.

(51) Int. Cl. G06F 15/16

(52) U.S. Cl. 709/202

(57) ABSTRACT

A computer system exchanges information between a central website and a plurality of electronic communication devices. Information is created on the central website. The information can be business reports, product information, or public service announcement. Bridging code is created which relates to the information. The bridging code is installed on the electronic communication devices. The central website maintains a list of the electronic communication devices, which include a commercial website, professional website, personal computer, and person communication device. The bridging code is embedded in computer executable code controlling each of the electronic communication devices. The bridging code is utilized to establish a communication link between the central website and each of the electronic communication devices. The information from the central website is automatically published asynchronously onto the electronic communication devices. The updated information is displayed on the electronic communication devices.

### CLAIM TO DOMESTIC PRIORITY

The present non-provisional patent application claims priority to provisional application Ser. No. 60/942,616, entitled “Social E-Commerce Software,” and filed on Jun. 7, 2007.

### CROSS-REFERENCE TO RELATED PATENT APPLICATIONS

The present patent application is related to copending U.S. Patent Application, Attorney Docket No. 129279.00004, entitled “System and Method of Bridging a Product Catalog from a Central E-Commerce Website to Remote Websites,” and filed concurrently herewith.

### FIELD OF THE INVENTION

The present invention relates in general to computer-based e-commerce systems and, more particularly, to a system and method for exchanging information between a central website and a plurality of electronic communication devices.

### BACKGROUND OF THE INVENTION

The Internet is a worldwide, publicly accessible collection or network of interconnected computer networks, linked by hard wires, fiberoptic cables, and wireless communications. The Internet transmits data by packet switching using an internet protocol (IP). The IP is a collection of standards and protocols organized into layers so that each layer provides the foundation and services required by another layer. The “network of networks” contains millions of smaller domestic, academic, business, and government computers and networks, which together disseminate vast quantities of information and services. The World Wide Web (Web) is one of the services accessible via the Internet, along with many others including electronic mail, file sharing, and interlinked webpages and documents, which are linked by hyperlinks and uniform resource locators (URL).

The Internet is used for many commercial and information exchange purposes. For example, the Web is commonly used to buy and sell products, transfer funding, and disseminate information. Consider an example where a merchant develops a website to market and sell products or services. In the present discussion, the concept of products and services are synonymous and used interchangeably. The merchant's website is addressable by a unique URL entered through a commercially available browser installed on a computer connected to the Internet. The website often contains multiple interlinked webpages, each organized to present varying levels of information and detail to aid the customer in evaluating the product to make a purchase decision. The website typically contains a catalog of products offered by the merchant. The customer browses the on-line catalog through the webpages and selects one or more products to review. Upon selecting a product to purchase, the website guides the customer through ordering, shipping, and payment webpages to complete the transaction.

The website is physically located on a single computer system controlled by the merchant. To view and use the website, the customer must enter the proper merchant URL. The customer remains on the merchant's website through the entire transaction. Some websites utilize one or more separate third party websites dedicated for the payment and shipping portions of the transaction. In addition, some websites provide links, commonly called banners, which transfer the customer to another commercial website to access related or sponsored products. In any case, the customer navigates one website at a time.

The presentation and organization of conventional commercial websites is limited in that the product catalog is available only on the merchant's home website. The merchant needs to maintain control of the quality and content of the website, which up to now has best been accomplished by operating a single website. The customer may search for specific products generally using a search engine, but ultimately must transfer to the merchant's website to gain full access to the product catalog. Many merchants would like to expand the exposure of their website and increase sales. Yet, the need to maintain the product catalog on a single website limits the ability to gain exposure on the Internet.

A similar limitation exists for those websites intended for information exchange. Posting new information on a single website does not necessarily disseminate that information to all persons that need to know or would like to know about the new information. Until each person visits the single website with the new posting, the information is not distributed as intended.

A need exists to easily expand the exposure of a website on the Internet without loss of quality or control over its contents.

### SUMMARY OF THE INVENTION

In one embodiment, the present invention is a computer-implemented method of exchanging information between a central website and a plurality of electronic communication devices comprising the steps of creating information on the central website, creating bridging code related to the information, and installing the bridging code on the electronic communication devices. The bridging code is embedded in computer executable code controlling each of the electronic communication devices. The method further includes the steps of utilizing the bridging code to establish a communication link between the central website and each of the electronic communication devices, automatically publishing the information from the central website onto the electronic communication devices, and displaying the updated information on the electronic communication devices.

In another embodiment, the present invention is a computer program product usable with a programmable computer processor having computer readable program code embodied therein comprising computer readable program code which creates information on the central website, creates bridging code related to the information, and installs the bridging code on the electronic communication devices. The bridging code is embedded in computer executable code controlling each of the electronic communication devices. The computer readable program code further utilizes the bridging code to establish a communication link between the central website and each of the electronic communication devices, automatically publishes the information from the central website onto the electronic communication devices, and displays the updated information on the electronic communication devices.

In another embodiment, the present invention is a computer system for exchanging information between a central website and a plurality of electronic communication devices comprising means for creating information on the central website, means for creating bridging code related to the information, and means for installing the bridging code on the electronic communication devices. The bridging code is embedded in computer executable code controlling each of the electronic communication devices. The computer system further includes means for utilizing the bridging code to establish a communication link between the central website and each of the electronic communication devices, means for automatically publishing the information from the central website onto the electronic communication devices, and means for displaying the updated information on the electronic communication devices.

### BRIEF DESCRIPTION OF THE DRAWINGS

FIG. 1 is a block diagram of a central e-commerce website communicating with multiple remote websites;

FIG. 2 is a flowchart of the process of using the e-commerce system;

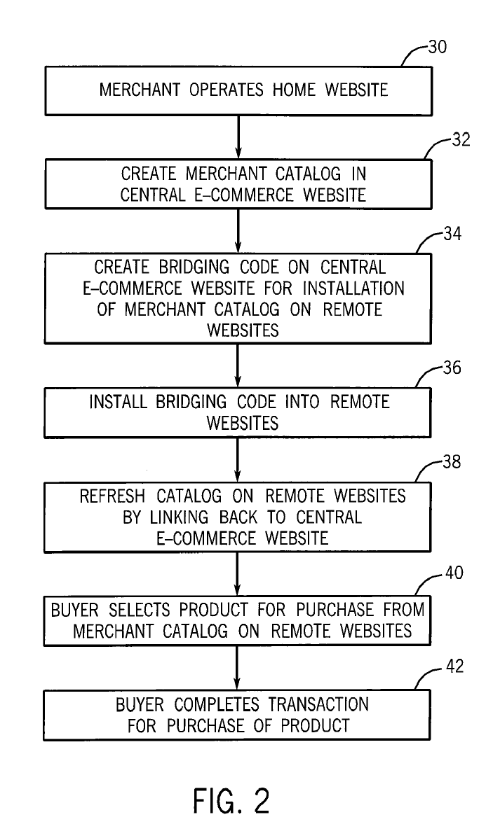

FIG. 3 is a computer system for executing the bridge linking between the central e-commerce website and the remote websites;

FIGS. 4a-4d are data entry screens for creating and managing the product catalog;

FIG. 5 illustrates bridge linking between the central e-commerce website and the remote websites;

FIG. 6 illustrates the remote website displaying the product catalog created on the central e-commerce website;

FIG. 7 illustrates bridge linking between the central e-commerce website and the electronic communication devices; and

FIG. 8 is a flowchart of using the e-commerce system.

### DETAILED DESCRIPTION OF THE DRAWINGS

The present invention is described in one or more embodiments in the following description with reference to the Figures, in which like numerals represent the same or similar elements. While the invention is described in terms of the best mode for achieving the invention's objectives, it will be appreciated by those skilled in the art that it is intended to cover alternatives, modifications, and equivalents as may be included within the spirit and scope of the invention as defined by the appended claims and their equivalents as supported by the following disclosure and drawings.

The present invention involves an e-commerce system that allows merchants (sellers), buyers, visitors, supporters, and other third parties to distribute individual stores and product catalogs across the Internet by offering embeddable “copy and paste” bridging code. The e-commerce system solves the above noted problem of traditionally driving web traffic and potential buyers to a single specific URL destination on the Internet. A virtual store and product catalog is first created on a central e-commerce website. A bridging code is assigned to the virtual store. The merchants can then distribute the virtual store to many other websites by copying and pasting the bridging code. Others can contribute by “copying and pasting” the bridging code associated with the merchant's virtual store. The process makes any seller's products and services accessible in multiple web locations and enhances e-commerce activity, transactions, and exposure. All transactions and revenue completed through the “copy and paste” stores are received by store owner or original merchant. Affiliate sellers can also profit from revenue generated by “copying and pasting” e-commerce stores.

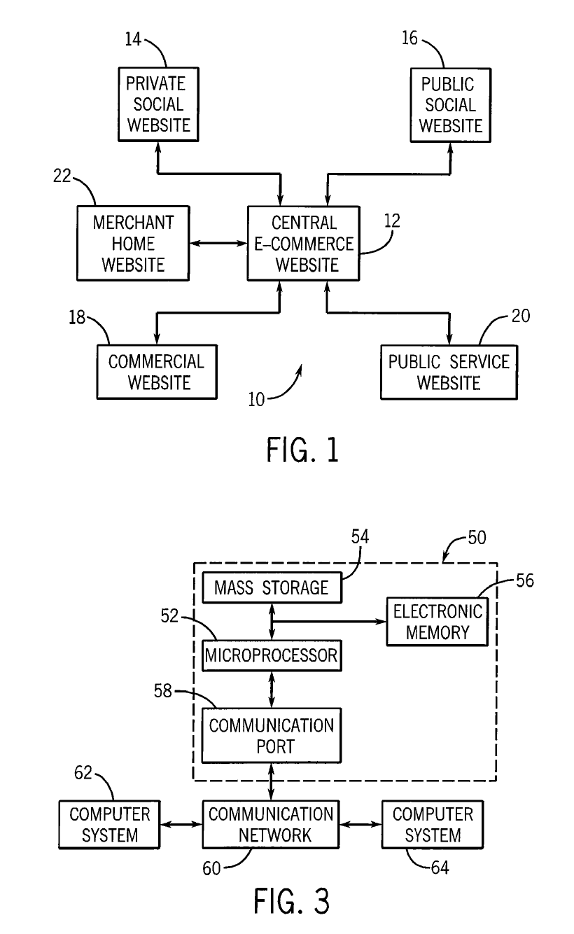

The present electronic commerce (e-commerce) system 10 is shown in FIG. 1. The e-commerce system 10 provides users the ability to extend or re-direct their website to other remote websites, i.e., websites that are separate and apart from a central e-commerce website 12 or the merchant's home website 22. Some examples of the remote websites include private social website 14, public social website 16, commercial website 18, and public service website 20.

Private social website 14 is a website designed for users to communicate with one another in a social manner. The website is private in that membership is based on criteria established by the website administrator. For example, private social website 14 may be set up for a particular religious group to share information and beliefs. Each member of the website may establish his or her own webpage for posting social information and communicating with other members, within the content standards of the website.

Public social website 16 is also a website designed for users to communicate with one another in a social manner. However, the website is public and has an open membership. Each member of the website may establish his or her own webpage for posting social information and communicating with other members, within the content standards of the website.

Commercial website 18 is a website designed for business purposes. The website may offer particular products or services for sale. Alternatively, the website may promote specific types of business and disseminate business information, e.g., insurance or health and fitness business. An administrator controls the content of commercial website 18.

Public service website 20 is a website designed for dissemination of information for public benefit. The website may offer notices and other information for public safety, emergency services, news, charity fund raising, “Amber Alerts,” and other information of public interest. An administrator controls the content of public service website 20.

In the present discussion, a user interacts with e-commerce system 10. The user may be a merchant, although any person, business, charity, government agency, service organization, or other entity could use e-commerce system 10. In block 30, the merchant operates its own home or main website 22 offering goods and services for sale. The home website is physically located on a single computer system controlled by the merchant. To view and use the website, a customer must enter the proper merchant URL. The merchant's website contains multiple interlinked webpages, each organized to present varying levels of information and detail to aid the customer in evaluating the product to make a purchase decision. In the present discussion, the concept of goods, products, and services are synonymous and can be used interchangeably. The website typically contains a catalog of products offered by the merchant. The customer browses the on-line catalog through the webpages and selects one or more products to review. Upon selecting a product to purchase, the website guides the customer through ordering, shipping, and payment webpages to complete the transaction.

In block 32, the merchant elects to expand its business by utilizing e-commerce system 10 to set up a virtual store and product catalog on one or more remote websites, which is not the merchant's home website 22. Each remote website is located in some other physical location on the Internet and has its own unique URL. The remote website may be private social website 14, public social website 16, commercial website 18, and/or public service website 20.

To set up the virtual store and product catalog on the remote website, the merchant uses central e-commerce website 12 to enter the product(s) intended for the remote website, which is described in detail below. The central e-commerce website 12 requires minimal effort to develop the virtual store and product catalog. The product information can be entered manually or imported from merchant's home website 22. In block 34, the central e-commerce website 12 generates, among other things, bridging software code for installation on the remote websites. The bridging code contains the computer executable instructions and data necessary to create the merchant's virtual store and product catalog on the remote website. The bridging code may be written in hyper text markup language (HTML).

In block 36, the bridging code is installed on the remote website. The logistics involved in installing the bridging code on the remote website vary depending on the website's policy and rules. For private social website 14 and public social website 16, the merchant would first have to be a member. In addition, the merchant/member would need authorization to install the bridging code on the remote website. Some social websites are open and generally provide the authorization to all members, within the website administration's guidelines for suitable and ethical subject matter. Other remote websites require express authorization.

For commercial website 18, the website administrator would likely require grant of express authorization prior to any installation of the bridging code. The commercial website administrator may establish standards and agreements which the merchant would have to comply with to gain authorization. In general, the authorization would likely be based on business value to commercial website 18 of installing the bridging code to create the merchant's virtual store and product catalog on the commercial website. The commercial website 18 may allow installation of bridging code for complimentary merchandise from other merchants, supply chain notices, or other relevant business information.

Public service website 20 would likely also require authorization and have similar guidelines for suitable and ethical subject matter, although the standard would be the best interest of the public.

Assume for the present discussion that the merchant is able to comply with the standards of each remote website and receive the necessary authorization. The bridging code created by central e-commerce website 12, which contains the computer executable instructions and data necessary to create the merchant's virtual store and product catalog, is then installed on the remote website. The bridging code is embedded in the computer executable code controlling the remote website. The bridging code, written in HTML, would be integrated within the body of software code controlling the remote website.

In block 38, in order to display the virtual store and product catalog, the bridging code installed in the remote website electronically links back to central e-commerce website 12 in an asynchronous manner and retrieves data stored on the central website. In one embodiment, the bridging code does not contain all data necessary to display the product catalog. Instead, the bridging code contains executable computer instructions and the URL necessary to link back to central e-commerce website 12. The bridging code further contains an identifier that matches the merchant's product data in the central e-commerce website. Central e-commerce website 12 retrieves the merchant's product data based on the merchant identifier. The product data from central e-commerce website 12 is sent back to the remote website and used to populate and display the merchant's virtual store and product catalog on the remote website. The product data downloaded from central e-commerce website 12 contains the latest information, e.g., images, text, pricing, promotions, and product information and availability, to present the merchant's virtual store and product catalog on the remote website.

In another embodiment, the bridging code installed on the remote website contains the last updated, most recent product data. The bridging code still links back to central e-commerce website 12 to confirm and, if necessary, refresh the merchant's product information. The merchant identifier may contain a version code that indicates whether the product data stored on the remote website is the most recent version or whether the product data on the remote website needs to be updated. If the product data on the remote website is the most recent version, then no product data transfer is necessary. The embodiment which stores the product data with the bridging code reduces the data transfer between the remote website and central e-commerce website 12 by avoiding unnecessary updates and increases the system throughput.

In block 40, the merchant's virtual store and product catalog are visible on the remote website for viewing and product selection by a customer. The customer is able to browse the merchant's product catalog on the remote website. In prior art websites, a banner or link seen on one website electronically transfers the customer to another website. The banner is simply a static link with an URL address for the destination website. The banner does not routinely change. In the present e-commerce system 10, the bridging code is fully functional computer executable software. The bridging code, in combination with the data from central e-commerce website 12, provides a complete product catalog on the remote website for the customer's review. During the process of evaluating the product and moving between catalog webpages and data entry screens, the customer remains on the remote website while browsing the catalog. The customer is not redirected from the remote website to the merchant's home website 22, or any other website, while browsing the product catalog and making product selections. Rather, the merchant is able to convey the same information that exists on central e-commerce website 12 onto the remote website.

In block 42, the customer makes a buying decision. The remote website handles shipping, payment, notices to customer, and transaction status. In another embodiment, the customer may be returned to central e-commerce website 12, or be re-directed to a dedicated payment website, to complete the transaction.

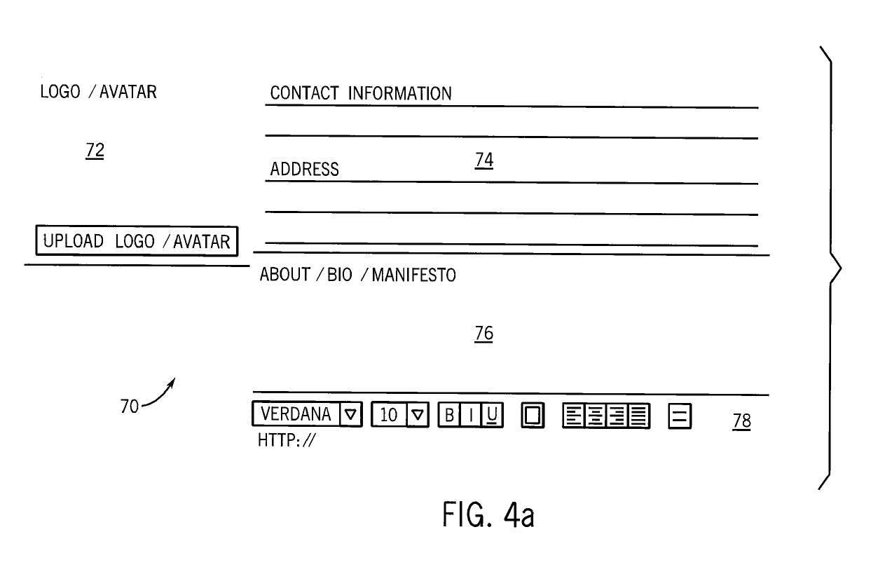

FIG. 3 illustrates a simplified computer system 50 for executing the software program used in the e-commerce system 10. Computer system 50 is a general-purpose computer including a central processing unit or microprocessor 52, mass storage device or hard disk 54, electronic memory 56, and communication port 58. Communication port 58 represents a modem, high-speed Ethernet link, or other electronic connection to transmit and receive input/output (I/O) data with respect to other computer systems.

Computer 50 is shown connected to communication network 60 by way of communication port 58. Communication network 60 can be a local and secure communication network such as an Ethernet network, global secure network, or open architecture such as the Internet. Computer systems 62 and 64 can be configured as shown for computer 50 or dedicated and secure data terminals. Computers 62 and 64 are also connected to communication network 60. Computers 50, 62, and 64 transmit and receive information and data over communication network 60.

When used as a standalone unit, computer 50 can be located in any convenient location. When used as part of a computer network, computers 50, 62, and 64 can be physically located in any location with access to a modem or communication link to network 60. For example, computer 50 can be located in the main office of the central e-commerce website administrator or coordinator. Computer 62 can be the private or public social website server. Computer 64 can be the commercial or public service website server. Alternatively, the computers can be mobile and follow the users to any convenient location, e.g., remote offices, customer locations, hotel rooms, residences, vehicles, public places, or other locales with electronic access to communication network 60.

Each of the computers runs application software and computer programs which can be used to display user-interface screens, execute the functionality, and provide the features of the e-commerce system 10. In one embodiment, the screens and functionality come from the application software, i.e., the e-commerce system 10 runs directly on one of the computer systems. Alternatively, the screens and functionality can be provided remotely from one or more websites on the Internet. The data entry screens described herein can be part of the application software running on a dedicated computer or part of a website accessed via the Internet. The websites are generally restricted-access and require passwords or other authorization for accessibility. Communications through such websites may be encrypted using secure encryption algorithms. Alternatively, the screens and functionality are accessible only on the secure private network, such as Virtual Private Network (VPN), with proper authorization.

The software is originally provided on computer-readable media, such as compact disks (CDs), magnetic tape, or other mass storage medium. Alternatively, the software is downloaded from electronic links such as the host or vendor website. The software is installed onto the computer system hard drive 54 and/or electronic memory 56, and is accessed and controlled by the computer's operating system. Software updates are also electronically available on mass storage media or downloadable from the central e-commerce website. The software, as provided on the computer-readable media or downloaded from electronic links, represents a computer program product usable with a programmable computer processor having computer-readable program code embodied therein. The software contains one or more programming modules, subroutines, computer links, and compilations of executable code, which perform the functions of e-commerce system 10. The user interacts with the software via keyboard, mouse, voice recognition, and other user-interface devices connected to the computer system.

The software stores information and data related to the e-commerce system in a database or file structure located on any one of, or combination of, hard drives 54 of the computers 50, 62, and/or 64. More generally, the information used in the e-commerce system 10 can be stored on any mass storage device accessible to computers 50, 62, and/or 64. The mass storage device for storing the e-commerce system data may be part of a distributed computer system.

In the case of Internet-based websites, the interface screens are implemented as one or more webpages for receiving, viewing, and transmitting information related to the e-commerce system 10. A host service coordinator may set up and administer central e-commerce website 12 from computer 50 located in the service coordinator's home office. The merchant accesses the webpages of the central e-commerce website from a computer connected to communication network 60.

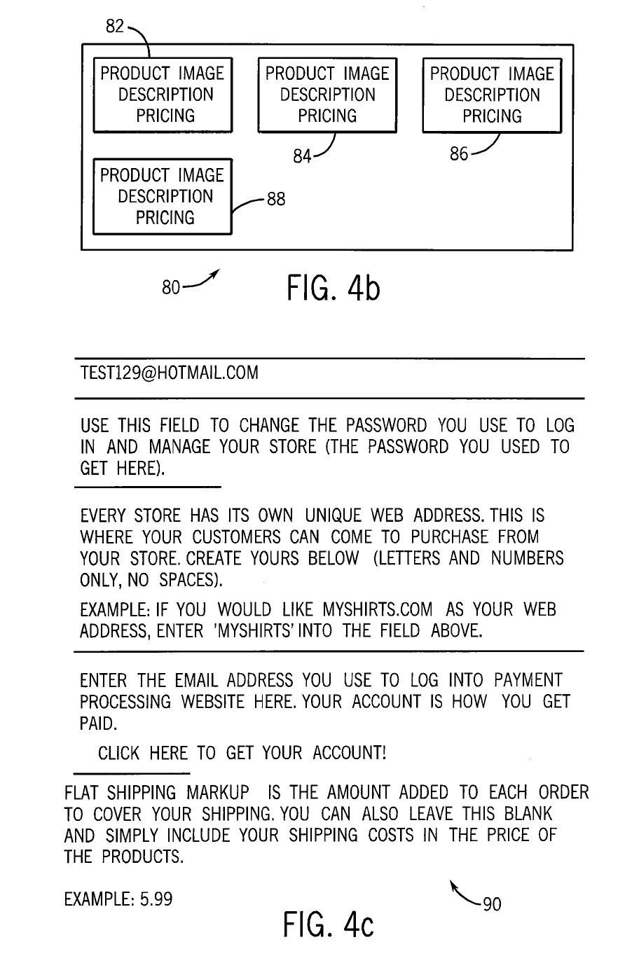

Further detail of blocks 32-42 is shown in FIGS. 4a-4d. The user or merchant creates a product catalog through a plurality of data entry screens in central e-commerce website 12. The product data is stored in a database on computer 50 or other mass storage device accessible to computer 50. Most webpages in the central e-commerce website 12 have selections or links across the top of the page for profile, manage products, account information, customize and share store, and feedback. The data entry boxes or fields allow the user to enter data into system 10. Some fields are general purpose and will accept any data. Other fields accept only predetermined values and may have a pull-down selection menu.

Webpage 70 provides for general merchant information. In block 72, the merchant has fields for its logo. Block 74 provides for merchant contact information such as name, address, phone number, and email address. Block 76 allows entry of transaction processing, shipping, payment, and general merchant information. Block 78 provides for custom text formatting. The merchant agrees to the terms and conditions of using central e-commerce website 12.

The merchant uses screen 80 in FIG. 4b to create the virtual store and product catalog. The individual products are added to the product catalog. Alternatively, the product data can be imported from the merchant's home website 22. As shown in FIG. 4b, the merchant has added item 82, 84, 86, and 88, each including product name, image, description, and pricing. For example, the items may be clothing, apparel, accessories, musical instrument, extreme sports equipment, artist supplies, photography, prints, health, jewelry, collectables, electronics, and other consumer products, just to name a few. In screen 80, items 82-88 are tee shirts. Other product information for tee shirts 82-88 includes size, color, and style. The merchant can customize colors and appearance of the store to complement its branding.

Screen 90 in FIG. 4c provides for management of the merchant's account, e.g., changing password, store identifier, and payment information.

Screen 100 in FIG. 4d provides for editing and updating the merchant's store and product catalog. The merchant can add a product with button 102. The merchant can change product image in block 104 and change product description in block 106. In block 108, the changes can be saved. In block 110, the merchant can upload new product images.

After all necessary information has been provided, the merchant's virtual store and product catalog is stored in the database on computer 50. A unique identifier is assigned for publishing the store to one or more remote websites. The publication makes the virtual store and product catalog publicly available to other websites on the Internet.

Once the store and product catalog are ready for release and publication, the central e-commerce website creates the bridging code for installation on the remote website. The merchant can copy the bridging code and insert or paste the code into the remote website. The bridging code contains information necessary for the remote website to load product data for the virtual store and product catalog created on the central e-commerce website. The product data is downloaded from central e-commerce website 12 and made available to the remote website to generate the merchant's virtual store and product catalog.

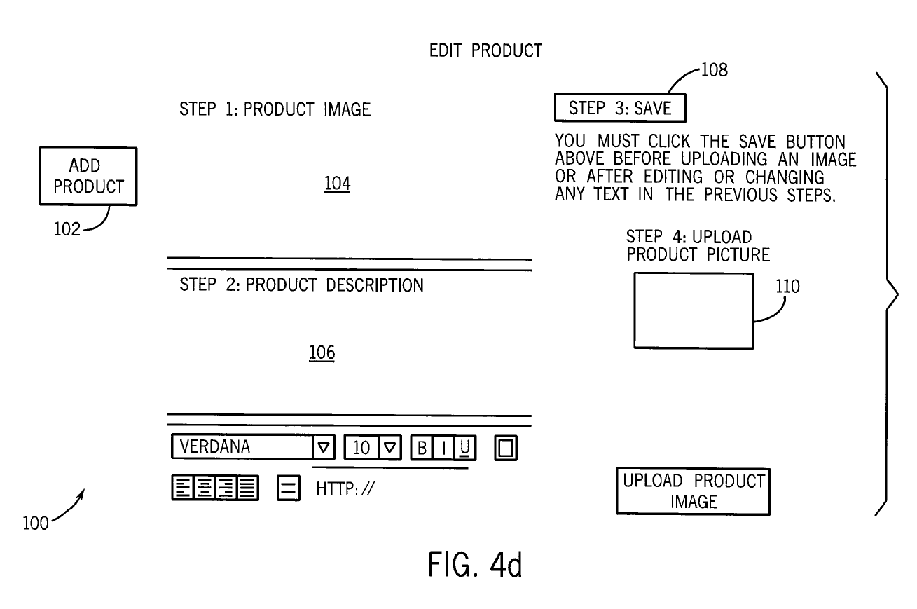

Assume one or more remote websites have agreed to have the bridging code installed on their websites. The website administrator has granted authorization to install the bridging code, provided the merchant agrees to comply with the standards for the remote website. Once installed, the bridging code becomes part of the HTML code which controls content of the remote website. The bridging code creates bridge link 120 between central e-commerce website 12 and remote websites 122 representing one or more of websites 14-20, as shown in FIG. 5.

As an example, if the target remote website is public social website 16, then the merchant copies the bridging code from central e-commerce website 12 and physically inserts or pastes the bridging code into the merchant's personal webpage on the public social website. The bridging code installed on public social website 16 electronically links back to central e-commerce website 12 in an asynchronous manner and retrieves data stored on the central website database. As noted above, the bridging code does not necessarily contain all product data needed to display the product catalog. The bridging code contains executable computer instructions and the URL to link back to central e-commerce website 12. The bridging code further contains an identifier that matches the merchant's product data in the central e-commerce website. Central e-commerce website 12 retrieves the merchant's product data based on the merchant identifier. The product data from central e-commerce website 12 is transferred to public social website 16 and used to populate and display the merchant's product catalog on the website. The product data from central e-commerce website 12 contains the latest information, e.g., images, text, pricing, promotions, and product information and availability, necessary to present the merchant's virtual store and product catalog on the remote website.

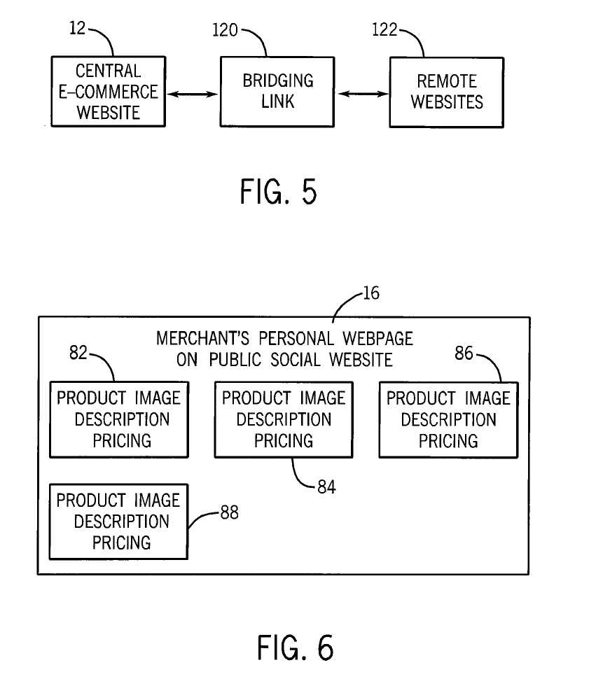

FIG. 6 illustrates the merchant's store and product catalog, substantially the same as created in central e-commerce website 12. The product catalog contains the same tee shirts 82-88 as set up in screen 80 of central e-commerce website 12. Each item 82-88 has an image, description, and pricing. The remote product catalog also matches color scheme for branding consistency.

In an alternate embodiment, the bridging code installed on the remote website may contain the last updated, most recent product data. The bridging code still links back to central e-commerce website 12 to refresh or confirm the merchant's product information. The merchant identifier may contain a version code that indicates whether the product data stored on the remote website is the most recent version or whether the product data on the remote website needs to be refreshed. If the product data on the remote website is the most recent version, then no update need be sent. The embodiment which stores the product data with the bridging code reduces the data transfer between the remote website and central e-commerce website 12 by avoiding unnecessary updates and increases the system throughput.

Any member of public social website 16 can browse the product catalog on the merchant's personal webpage. During the process of evaluating the product and moving between catalog webpages and data entry screens, the member remains on public social website 16. The customer is not redirected from the public social website to the merchant's home website 22, or any other website, while browsing the product catalog and making product selections on public social website 16.

The bridge linking to update the product catalog on public social website 16 can be automatic as described above or manual in that the member can execute a refresh the webpage which causes the website to confirm or update its product information from central e-commerce website 12.

Assume the member makes a decision to buy one of the merchant's products. The member must checkout the items selected for purchase. As noted above, the checkout process can occur on public social website 16, or central e-commerce website 12, or other commercial payment website. The checkout process includes webpages displaying the item purchased, billing information, shipping information, tracing, feedback, order history, inventory, and transaction status. The central e-commerce website 12 receives a commission or fee for the transaction.

Any visitor, buyer, or supporter to the merchant's webpage on the public social website can re-publish the merchant's virtual store to other websites by copying and pasting the bridging code. If the visitor likes the merchant's store and wants to post the store on another web location, the visitor simply copies the bridging code from the merchant's webpage and pastes the code on another webpage in public social website 16, or any other remote website. The copying and pasting of the bridging code can be repeated an unlimited number of times. Each new webpage or website that receives the bridging code electronically connects to central e-commerce website 12, as described above, downloads the product data, and displays the merchant's virtual store and product catalog. The unlimited replication or re-publishing of the bridging code increases visibility and accessibility of the merchant's virtual store and product catalog. The bridging code can also be re-published to any commercial website by a seller, buyer, or visitor who wishes to replicate the merchant's virtual store and product catalog. Products can be purchased through these other websites as described above. The revenue generated is received for the benefit of the merchant and shared as per any agreement with the commercial website.

In another embodiment, the central e-commerce website can auto-publish to select remote websites. The auto-publish feature simplifies the installation process to a large number of remote websites. The central e-commerce website would maintain a list of remote websites which have authorized posting of bridging code. The merchant need not determine which website to copy the bridge code to. The central e-commerce website uses the list of remote websites which accept bridging code to automatically install the bridging code through pre-arranged distribution channels, which can be implemented through portals or realtime push syndication to the remote websites.

The merchant's product catalog can represent an aggregation of data which the merchant or other user has assembled for display on the remote website. The merchant may create a product catalog of items from different merchants. For example, the merchant may create a product catalog of the “best tee shirts” related to rock and roll music. The “best tee shirts” may come from different manufacturers and vendors. The product catalog created on central e-commerce website 12 is an aggregation of those items. The merchant may grant permission to others to update the product catalog on central e-commerce website 12 with additional items. In another example, the catalog may be products related to child safety. The merchant chooses the best products from different vendors and creates an aggregate product catalog on central e-commerce website 12. In another example, the catalog created on central e-commerce website 12 can be a series of public service notices. In another example, the catalog created on central e-commerce website 12 may relate to charities or political fundraising. In any event, the aggregation of information can be copied and pasted to one or more remote websites from the central e-commerce website as described above.

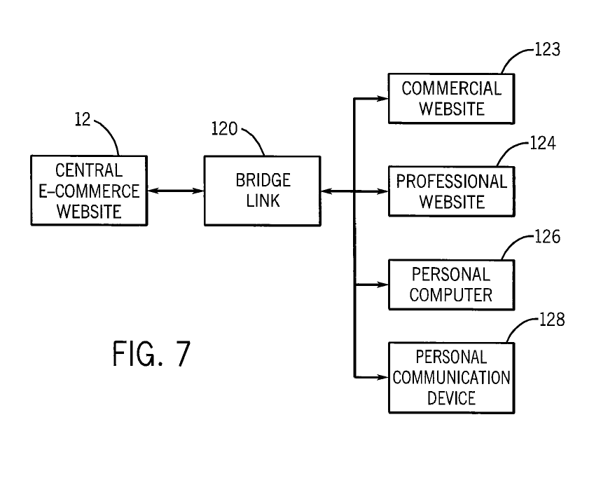

In an enterprise model of e-commerce system 10, central e-commerce website 12 is used to simultaneously communicate with a large number of users. FIG. 7 illustrates central e-commerce website 12 electronically communicating with electronic communication devices by bridge link 120. The electronic communication devices include commercial website 123, professional website 124, personal computer 126, and personal communication device 128, e.g., cell phone or personal digital assistant (PDA). Once the bridging code is installed, the contents of the catalog created on the central e-commerce website are automatically displayed on the electronic communication devices. The concept of a catalog can be extended to a collection of information. In some businesses, such as insurance sales, the central authority is required to update all agents at the same time. The insurance company need only install bridging links to each agent electronic communication device and then post any new information to central e-commerce website. In another example, advertisers may want to send out advertisements to a list of customers, e.g., offering a limited time promotion. Central e-commerce website 12 maintains a list of the electronic communication devices to receive the information. The information is automatically and simultaneously distributed by bridge link 120 and displayed on all selected or authorized electronic communication devices.

The central e-commerce website 12 can be used for on-line franchising. The franchiser creates the product catalog on central e-commerce website 12 and publishes the bridging code to the franchisee websites. The franchiser can change the product catalog at will and automatically update the franchisees' websites.

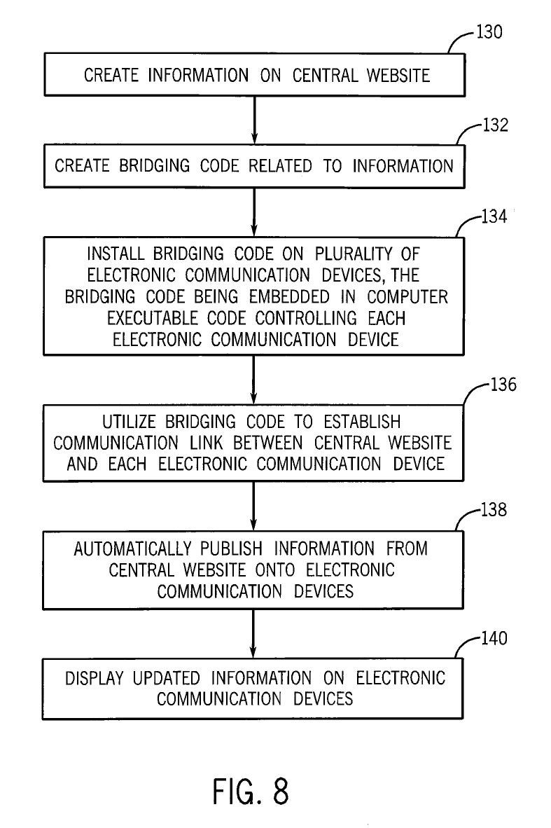

FIG. 8 illustrates the steps involved in exchanging information between a central website and a plurality of electronic communication devices. In step 130, information is created on the central website. The information can be product information, business report, or public service announcement. In step 132, bridging code is created which relates to the information. In step 134, the bridging code I installed on the electronic communication devices. The bridging code is embedded in computer executable code controlling each of the electronic communication devices, which include a commercial website, professional website, personal computer, and person communication device. The central website maintains a list of the plurality of electronic communication devices. In step 136, the bridging code is utilized to establish a communication link between the central website and each of the electronic communication devices. In step 138, the information from the central website is automatically published asynchronously onto the electronic communication devices. In step 140, the updated information is displayed on the electronic communication devices.

While one or more embodiments of the present invention have been illustrated in detail, the skilled artisan will appreciate that modifications and adaptations to those embodiments may be made without departing from the scope of the present invention as set forth in the following claims.

What is claimed is:

1. A computer-implemented method of exchanging information between a central website and a plurality of electronic communication devices, comprising:
creating information on the central website;
creating bridging code related to the information;
installing the bridging code on the plurality of electronic communication devices, the bridging code being embedded in computer executable code controlling each of the plurality of electronic communication devices;
utilizing the bridging code to establish a communication link between the central website and each of the plurality of electronic communication devices;
automatically publishing the information from the central website onto the plurality of electronic communication devices; and
displaying the updated information on the plurality of electronic communication devices.

2. The computer-implemented method of claim 1, further including updating the information on the central website.

3. The computer-implemented method of claim 1, wherein the plurality of electronic communication devices include a device selected from the group consisting of a commercial website, professional website, personal computer, and person communication device.

4. The computer-implemented method of claim 1, wherein the central website maintains a list of the plurality of electronic communication devices.

5. The computer-implemented method of claim 1, wherein the information is product information.

6. The computer-implemented method of claim 1, wherein the information is a business report.

7. The computer-implemented method of claim 1, wherein the information is a public service announcement.

8. The computer-implemented method of claim 1, wherein the information is published asynchronously.

9. A computer program product usable with a programmable computer processor having computer readable program code embodied therein, comprising:
computer readable program code which creates information on the central website;
computer readable program code which creates bridging code related to the information;
computer readable program code which installs the bridging code on the plurality of electronic communication devices, the bridging code being embedded in computer executable code controlling each of the plurality of electronic communication devices;
computer readable program code which utilizes the bridging code to establish a communication link between the central website and each of the plurality of electronic communication devices;
computer readable program code which automatically publishes the information from the central website onto the plurality of electronic communication devices; and
computer readable program code which displays the updated information on the plurality of electronic communication devices.

10. The computer program product of claim 9, further including computer readable program code which updates the information on the central website.

11. The computer program product of claim 9, wherein the plurality of electronic communication devices include a device selected from the group consisting of a commercial website, professional website, personal computer, and person communication device.

12. The computer program product of claim 9, wherein the central website maintains a list of the plurality of electronic communication devices.

13. The computer program product of claim 9, wherein the information is product information.

14. The computer program product of claim 9, wherein the information is a business report.

15. The computer program product of claim 9, wherein the information is a public service announcement.

16. The computer program product of claim 9, wherein the information is published asynchronously.

17. A computer system for exchanging information between a central website and a plurality of electronic communication devices, comprising:
means for creating information on the central website;
means for creating bridging code related to the information;
means for installing the bridging code on the plurality of electronic communication devices, the bridging code being embedded in computer executable code controlling each of the plurality of electronic communication devices;
means for utilizing the bridging code to establish a communication link between the central website and each of the plurality of electronic communication devices;
means for automatically publishing the information from the central website onto the plurality of electronic communication devices; and
means for displaying the updated information on the plurality of electronic communication devices.

18. The computer system of claim 17, further including means for updating the information on the central website.

19. The computer system of claim 17, wherein the plurality of electronic communication devices include a device selected from the group consisting of a commercial website, professional website, personal computer, and person communication device.

20. The computer system of claim 17, wherein the central website maintains a list of the plurality of electronic communication devices.

21. The computer system of claim 17, wherein the information is a business report.

22. The computer system of claim 17, wherein the information is product information.

23. The computer system of claim 17, wherein the information is a public service announcement.

24. The computer system of claim 17, wherein the information is published asynchronously.
